(19) United States
(12) Patent Application Publication
(10) Pub. No.: US 2004/0066351 A1
(43) Pub. Date: Apr. 8, 2004

(54) Bended dual-polarization antenna

(75) Inventor: Sheng Ming Deng, Hsinchu City (TW)

Correspondence Address: BRUCE H. TROXELL, SUITE 1404, 5205 LEESBURG PIKE, FALLS CHURCH, VA, 22041, US

(73) Assignee: INPAQ TECHNOLOGY CO., LTD.

(21) Appl. No.: 10/261,941

(22) Filed: Oct. 2, 2002

(51) Int. Cl. H01Q 9/16

(52) U.S. Cl. 343/806; 343/803; 343/702

(57) ABSTRACT

A bended dipole antenna, which comprises an antenna substance and a radiator led out from the antenna substance, is characterized in that: the conductor in the radiator is bended and an included angle is formed between the radiator and the antenna substance, thus the antenna can be assembled to most positions of a personal electronic apparatus for wireless transmission, and a well effect on both vertical polarization and horizontal polarization can be accomplished.

### BACKGROUND OF THE INVENTION

1. Field of the Invention

The present invention relates to an antenna, especially to a bended dipole antenna, which is provided with well polarization efficiency in the vertical and the horizontal, and is suitable to be assembled to the personal electronic apparatuses so as to accomplish wireless communication.

2. Description of the Prior Art

A conventional antenna for the personal electronic apparatus has the disadvantages as below:

(1) Since the radiator 200 is partially led out from the antenna substance 100 without any support, it can be extended freely and the entire appearance would be badly influenced.

(2) As the radiator 200 is partially extended and placed horizontally, it results in a worse polarization efficiency in the vertical.

(3) Since the radiator 200 is partially supported by nothing, the position for assembling the radiator is restricted in order to maintain the integrality of the personal electronic apparatus.

The present invention is created finally after being analyzed and tested repeatedly by the inventor of the present invention who focused on the above-mentioned disadvantages of the conventional antenna for the personal electronic apparatus.

### SUMMARY OF THE INVENTION

Accordingly, it is an object of the present invention to provide an antenna, of which the radiator is supported with a specific angle with the antenna substance 100, so it cannot be extended freely as it is assembled to the electronic apparatus so as to maintain the integrality of the electronic apparatus.

According to the antenna of the present invention, since there is a specific angle between the radiator and the antenna substance thereof, a better effect on vertical polarization of the antenna and a good transmission capability can be obtained. This is another object of the present invention.

According to the antenna of the present invention, since the radiator thereof is supported firmly, it can be assembled to most positions of the electronic apparatus and the integrality of the electronic apparatus is still maintained. This is a further object of the present invention.

The present invention will be better understood and its numerous objects and advantages will become apparent to those skilled in the art by referencing to the following drawings.

### BRIEF DESCRIPTION OF THE DRAWINGS

FIG. 1A is a perspective view of the conventional antenna that is assembled to the personal electronic apparatus.

FIG. 1B is an illustrative view showing operation of the conventional antenna according to FIG. 1A.

FIG. 2 is a perspective view of an example of the present invention.

FIG. 3 is a perspective view of another example of the present invention.

FIG. 4 is a perspective view showing an embodiment that the antenna of the present invention is assembled to an electronic apparatus.

### DETAILED DESCRIPTION OF THE PREFERRED EMBODIMENT

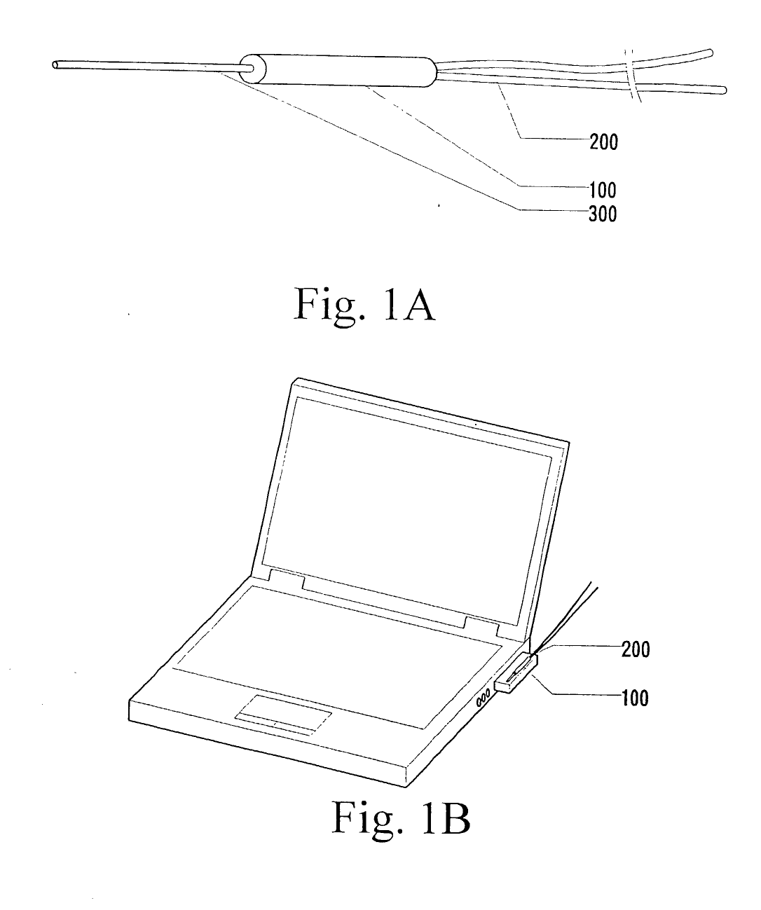

FIG. 1A is a perspective view of the conventional antenna that is assembled to the personal electronic apparatus, and FIG. 1B is an illustrative view showing operation of the conventional antenna according to FIG. 1A. The constitution and the disadvantages of the antenna as shown in the two figures has been specified as above, and it is not repeated here.

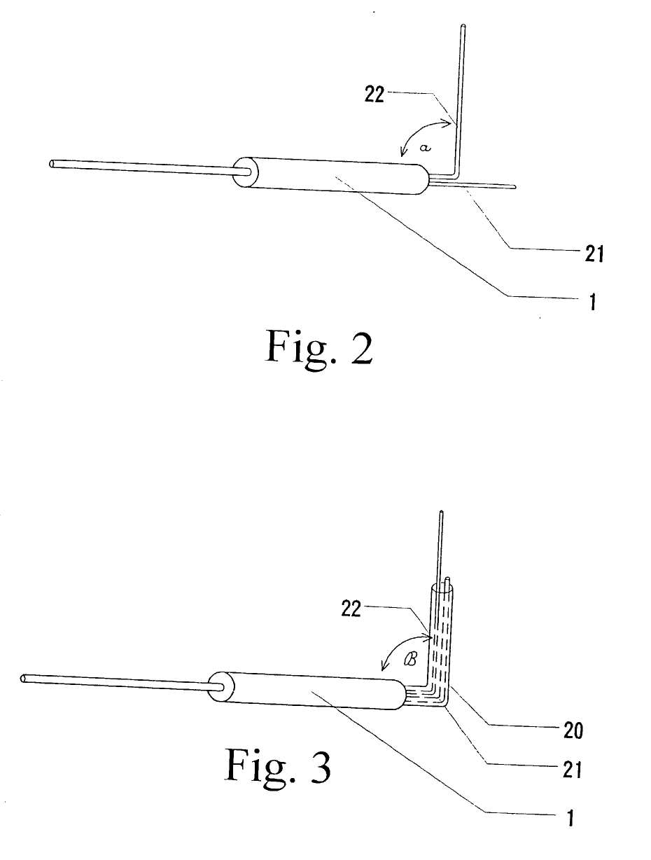

As shown in FIG. 2, the bended antenna of the present invention comprises an antenna substance 1 and a radiator 21 (22) led out therefrom the antenna substance 1; there maybe one radiator or two radiators. An included angle α is formed between the radiator 21 (22) and the antenna substance 1; and in order to form the angle α with specific degrees, the radiator 21 (22) can be a conductor proceeded with special treatment, such as a high practicable embodiment—a bendable and shapable conductor coated with a plastic layer.

Further, the bended antenna of the present invention as shown in FIG. 3, of which the radiator 21 (22) led out from the antenna substance 1 can be coated or covered with a supporter 20 in order to maintain an angle β between the antenna substance 1 and the radiator 21 (22).

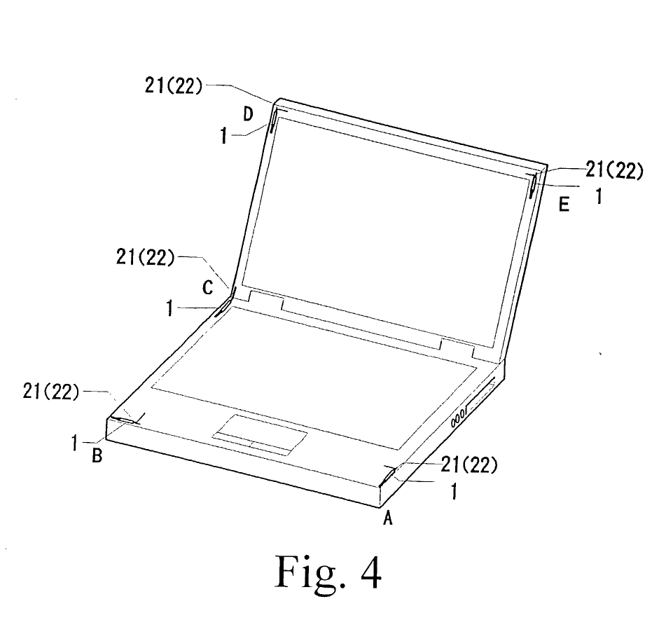

An embodiment of the antenna according to the present invention is shown in FIG. 4. Since an included angle is formed between the antenna substance 1 and the radiator 21 (22) led out therefrom, the antenna of the present invention can be assembled to most positions of the electronic apparatus conveniently, such as a side wall (A) of the host, a corner (B)/(C) on the surface, or the corner (D)/(E) of the panel etc. in a notebook computer. It can be assembled into a note book computer integrally and the appearance of the notebook computer is not influenced. In addition, because of the angle between the antenna substance 1 and the radiator 21 (22), it results in extremely well effect on both vertical polarization and horizontal polarization.

It is known from the above description that the bended dipole antenna according to the present invention is appropriate to be assembled to most positions of the electronic apparatus, and it is provided with well effect on both vertical polarization and horizontal polarization, thus the disadvantage of bad polarization effect of the conventional antenna is improved.

Although the present invention has been described using specified embodiment, the examples are meant to be illustrative and not restrictive. It is clear that many other variations would be possible without departing from the basic approach, demonstrated in the present invention.

What is claimed is:

1. A bended dipole antenna, which comprises an antenna substance and a radiator led out from the antenna substance, characterized in that: the conductor in the radiator is bended and an included angle is formed between the radiator and the antenna substance, thus the antenna can be assembled to most positions of a personal electronic apparatus for wireless transmission, and a well effect on both vertical polarization and horizontal polarization can be accomplished.

2. The antenna as claimed in claim 1, wherein the radiator is bendable after it is processed and an included angle is formed between the radiator and the antenna substance.
